(19) United States
(12) Patent Application Publication
(10) Pub. No.: US 2007/0138167 A1
(43) Pub. Date: Jun. 21, 2007

(54) Heated food warmer

(76) Inventors: Nitai Friedman, Montral (CA); Stephen P. Kucer, Hampstead (CA)

Correspondence Address: BANNER & WITCOFF, LTD., TEN SOUTH WACKER DRIVE, SUITE 3000, CHICAGO, IL, 60606, US

(21) Appl. No.: 11/318,658

(22) Filed: Dec. 21, 2005

(51) Int. Cl. H05B 3/44

(52) U.S. Cl. 219/544

(57) ABSTRACT

A heated display case for supporting and warming food items has a base, a frame, and a plurality of heated shelves supported by the frame. Each shelf has an upper layer, a lower layer, and a middle layer sandwiched between the upper and lower layers. The middle layer has a heating element embedded within a substrate to heat the shelf. A power supply is connected to each heating element to supply power to heat the shelves, and a controller is used to adjust the temperature of the shelves.

### TECHNICAL FIELD

The invention relates to an apparatus for warming food items, and more specifically, to a food display case having heated shelves.

### BACKGROUND OF THE INVENTION

Food warmers, such as display cases and ovens, for holding and warming food items and for keeping prepared foods at elevated temperatures prior to sale at restaurants, food counters, cafeterias, etc. are known. Such food warmers typically include one or more shelves for supporting prepared food items, and are capable of generating heat for warming the items supported by each shelf. Food warmers such as these typically have a conductive heat source below the food items and/or a heat lamp or other radiant heat source located above the food items. The food items may also be warmed by convected heat from a warm stream of air aimed at the items.

Such food warmers, however, have a significant drawback. Because the shelves of these known food warmers are typically made of an opaque material such as metal, the user or consumer's view of food items located on lower shelves is often blocked or impeded. Thus, food items located on lower shelves often are less accessible, resulting in reduced consumer interest and making monitoring the condition of the food items placed on lower holding surfaces more difficult.

Accordingly, it would be advantageous to provide a food warmer including at least one transparent heating shelf that overcomes these and other disadvantages. It would also be advantageous to provide a food warmer including a transparent shelf capable of supporting and heating food items. The use of one or more generally transparent heating shelves would allow for increased visibility. Further, it would be advantageous to provide a heat source of sufficient power capacity to warm food items and maintain such items at a desired temperature by distributing heat across a transparent shelf. It would be advantageous to provide a heat source for a display case having a relatively simple structure with no moving parts, thus providing improved reliability and maintainability.

The present invention is provided to solve the problems discussed above and other problems, and to provide advantages and aspects not provided by prior display cases of this type. A full discussion of the features and advantages of the present invention is deferred to the following detailed description, which proceeds with reference to the accompanying drawings.

### SUMMARY OF THE INVENTION

The present invention provides a food display case having heated shelves.

According to one aspect of the invention, the shelf has a first layer, a second layer, and a third layer positioned between the first layer and the second layer. The third layer includes a substrate having a heating element embedded therein, and the heating element is adapted to be connected to a power source.

According to another aspect of the invention, the display case has a support structure supporting the shelf.

According to another aspect of the invention, the third layer is in substantially continuous contact with the first layer and the second layer.

According to another aspect of the invention, the heating element is a mesh of resistive wires.

According to another aspect of the invention, the first layer, the second layer, and the third layer are generally transparent, providing a generally transparent shelf.

According to another aspect of the invention, the first layer and the second layer are made of glass, and the substrate of the third layer is made of plastic.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of a heated display case according to the present invention;

FIG. 2 is a front view of the display case of FIG. 1;

FIG. 3 is a side view of the display case of FIG. 1, with phantom lines showing structural outlines;

FIG. 4 is a perspective view of a shelf of the display case of FIG. 1;

FIG. 5 is a top view of the shelf of FIG. 4;

FIG. 6 is an exploded view of one embodiment of a shelf of a display case according to the present invention;

FIG. 7 is a magnified top view of a portion of the shelf of FIG. 6, indicated by circle 7 in FIG. 6; and,

FIG. 8 is a cross-sectional view taken along lines 8-8 of FIG. 7.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

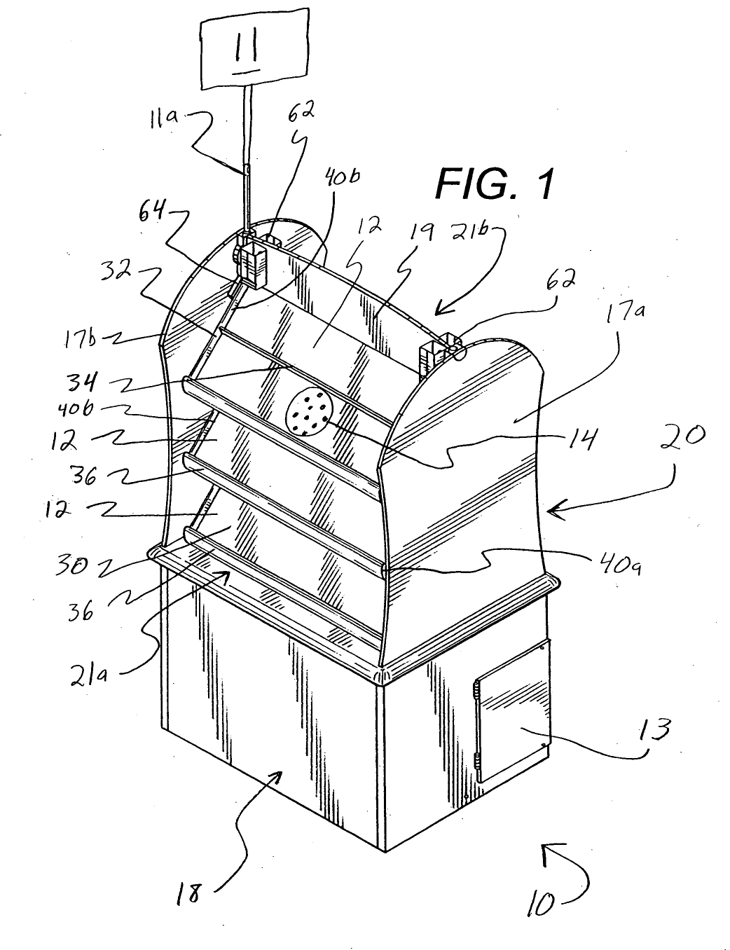

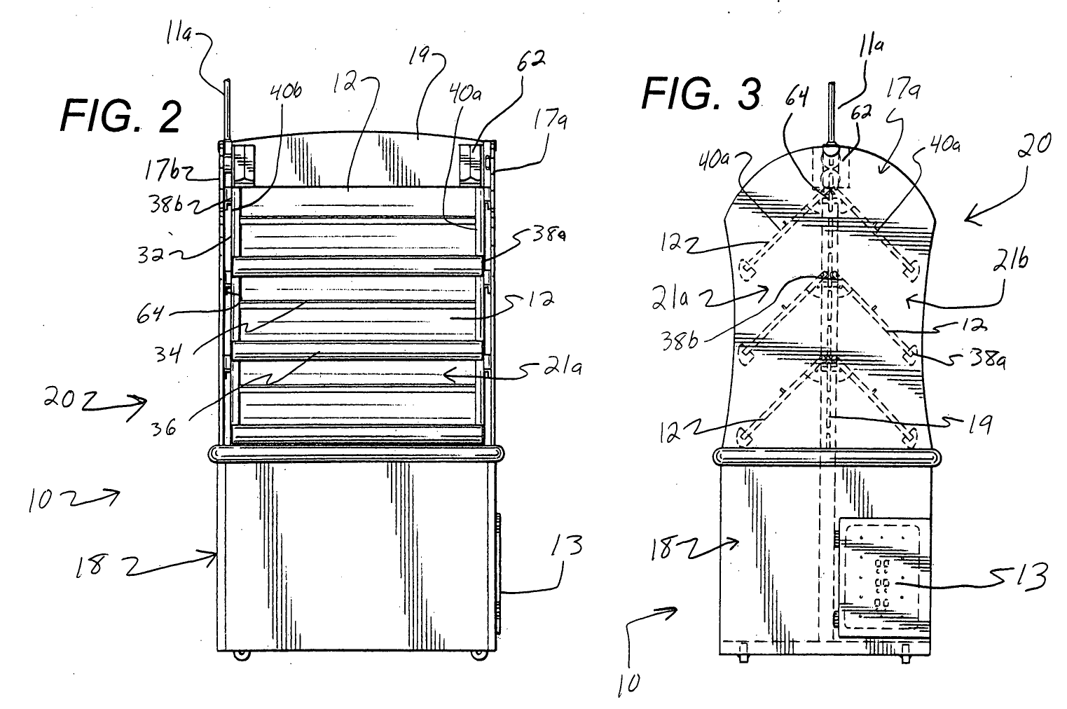

Referring to FIGS. 1-3, a heated display case 10 includes a plurality of generally transparent heating shelves 12 for warming and holding food items 14, for example, baked goods such as cookies. The display case 10 includes a rectangular base 18, and a frame 20 that extends upwardly from base 18. The frame 20 is secured by, for example, welding or fasteners such as screws. Six shelves 12 are removably connected to the frame 20 and are positioned above the base 18 and in spaced relation to the base 18. Food items 14 may be placed on shelves 12. Food items 14 placed on one of the shelves 12 are visible through the shelf 12 above, due to the generally transparent nature of shelves 12. Some or all of the shelves 12 can be generally transparent. The display case 10 also preferably includes a power source 11, such as a connection to a 120 V electrical outlet, and a controller 13 used to operate features and components of the display case 10, such as adjusting the temperature. Further, the display case 10 preferably includes a temperature-sensing mechanism (not shown), such as a thermostat, that cooperates with the controller 13 to regulate the temperature of the shelves 12.

As shown in FIGS. 1-3, the base 18 and frame 20 combine to form a support structure 15 supporting the shelves 12 of the display case 10. The base 18 is preferably rectangular and configured to sit upon a flat surface. The frame 20 includes opposed first and second vertical side supports 17a,17b and a central vertical support 19 fixedly secured to the base 18 and upwardly and perpendicularly extending from the base 18. The vertical supports 17,19 are fixedly secured by welding or by fasteners, such as screws inserted through apertures (not shown). The side supports 17 are preferably oriented parallel to each other and spaced apart at opposing edges of the base 18. The center support 19 is preferably placed between the side supports 17 and is oriented perpendicularly to the side supports 17, dividing the display case 10 into a front section 21a and a rear section 21b, as viewed with reference to FIGS. 1 and 2. Each section 21 preferably has three shelves 12 for displaying food items 14 thereon. In the preferred embodiment, the display case 10 is open, but in another embodiment, the display case 10 may contain a protective shell or housing to shield the food items 14 from the environment.

A preferred embodiment of the shelf 12 of the present invention is shown in FIGS. 4-8. The shelf 12 preferably has a generally transparent pane 30 with a support assembly 32, a divider 34, and an extrusion 36 thereon. The support assembly 32 includes front support brackets 38a and rear support brackets 38b positioned along two opposing edges 40 so that each edge has a pair of support brackets 38. Additionally, the support assembly 32 includes a pair of barriers 42 for preventing food items 14 from sliding off the edges of the shelf 12. The divider 34 extends across the middle of the shelf 12 and serves as a support to abut food items 14 placed on the shelf 12 and prevent them from sliding to the front of the shelf 12. An extrusion 36 extends across the front of the shelf 12 and similarly serves as a support to abut food items 14 placed on the shelf 12 and prevent them from sliding off the shelf 12. The extrusion 36 may also serve as a protector for one or more light-emitting diodes (LED's) or other light source (not shown) to light the shelves 12 and/or the display case 10. Preferably, the support assembly 32 also helps to hold the divider 34 and the extrusion 36 in place on the shelf 12.

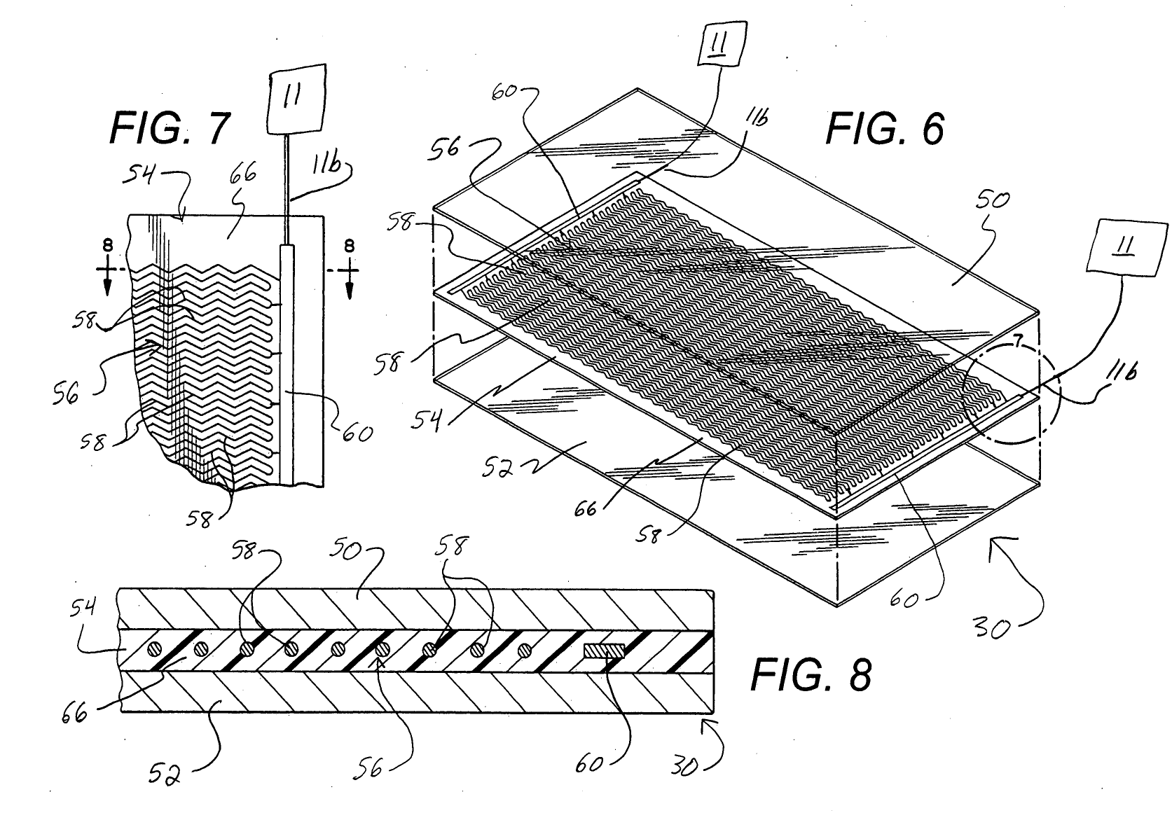

The shelf 12 is preferably heated and is preferably generally transparent. However, in alternate embodiments, the shelf 12 may be translucent or opaque. As illustrated in FIGS. 6-8, the pane 30 of the shelf 12 generally includes a first layer 50, a second layer 52, and a third layer 54 that contains a heating element 56. In the preferred embodiment shown in FIGS. 6-8, the first layer 50 is an upper layer, the second layer 52 is a lower layer, and the third layer 54 is a middle layer. Preferably, the first layer 50 and second layer 52 are generally transparent and made of glass, but may be made of another suitable material, such as synthetic stone or Plexiglas (acrylic sheet). Further, the first layer 50 and/or second layer 52 may not be transparent, and may be translucent or opaque. The third layer 54 is preferably sandwiched tightly between the first layer 50 and the second layer 52 so that one surface of the third layer 54 is in substantially continuous contact with the first layer 50 and the opposing surface of the third layer 54 is in substantially continuous contact with the second layer 52, so that few or no air gaps exist between the layers 50,52,54. In one preferred embodiment, the third layer 54 is substantially continuously bonded to the first layer 50 and the second layer 52 by an autoclaving process. Preferably, the three layers 50,52,54 are sealed together around the peripheries to create an airtight seal.

In the embodiment shown in FIGS. 6-8, the third layer 54 includes a substrate 66 having the heating element 56 embedded therein. The substrate 66 is preferably generally transparent and made of plastic, preferably polyvinylbutyral (PVB), but may be made of another suitable material. In other embodiments, the layers 50,52,54 may be arranged in a different order, or the shelf 12 may have a greater or smaller number of layers. In alternate embodiments, the third layer 54 may consist of only the heating element 56.

Preferably, the heating element 56 is a resistive wire 58 or a plurality of resistive wires 58. The heating element 56 of the preferred embodiment shown in FIGS. 6-8 is a mesh of resistive wires 58. The resistive wires 58 generate heat when an electrical current is passed through, heating the shelf 12. Additionally, the wires 58 preferably have an extremely small diameter and are spaced apart to allow a great deal of light to pass unobstructed through the shelf 12, allowing the shelf 12 to be generally transparent. The wires 58 are preferably connected to one or both of two bus bars 60 that are connected via connecting wires 11b to the power source 11. The wires 58 are preferably connected to each bus bar 60 at a plurality of locations, but alternately, the wires 58 may only be connected at one point to each bus bar 60. The bus bars 60 are preferably embedded in the third layer 54 along with the wires 58, as shown in FIGS. 6-8. The shelf 12 could have a different number of bus bars 60 in another embodiment. Alternately, the wires may be connected to the power source 11 in another manner.

In other embodiments, the heating element 56 may take a different form. For example, the heating element 56 may be a different type of electrically-tesistive element, such as a transparent resistive coating, which is used in heating aircraft windows. Additionally, the heating element 56 may not be an electrically-resistive element. For example the heating element 56 may take the form of clear liquid channels carrying heat to the shelf. Alternately, the heating element 56 may be a series of magneto-resistive elements between the layers 50,52,54, which are heated by applying a magnetic field to the shelf 12. Further, the heating element 56 may contain thicker, more clearly visible wires, such as those used in heating automobile windows. Still further, the heating element 56 may not be transparent, and may be translucent or opaque instead.

One preferred embodiment of the assembled display case 10 is illustrated in FIGS. 1-3. As shown, the frame 20 is affixed to the base 18 so that the frame 20 extends upward from the base 18. The two vertical side supports 17 extend upwardly from opposed edges of the base 18, and braces 62 proximate the tops of the side supports 17 hold the central support 19 in place. The central support 19 bisects the base and the side supports 17 to create relatively equal front 21a and back sections 21b. The front section 21a and the back section 21b each preferably contain an equal number of shelves 12. In a preferred embodiment, the display case 10 has three shelves in each section 21.

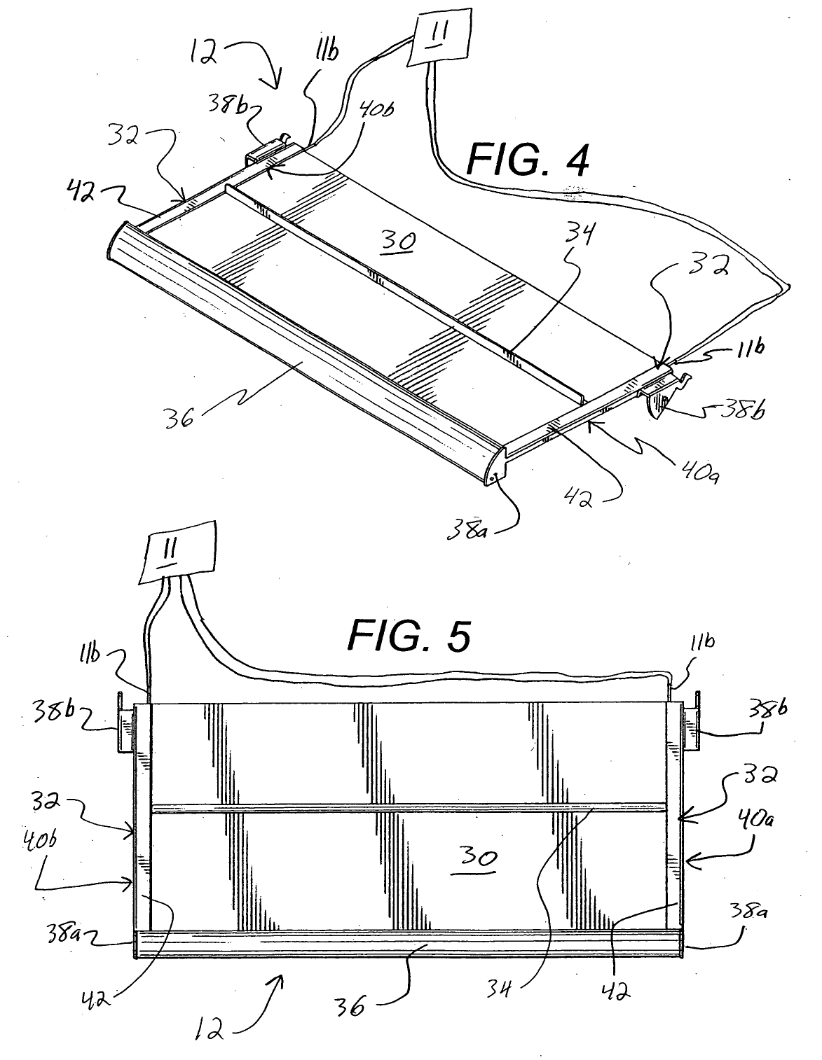

Each shelf 12 is preferably connected at a first edge 40a to the first vertical side support 17a and at a second edge 40b to the second vertical side support 17b to support the shelf 12 in spaced relation to the base 18. Preferably, the support brackets 38 on each edge 40 of the shelf 12 provide connection points for connection to the side supports 17. The rear brackets 38b shown in FIGS. 4-5 are preferably connected to the side supports 17 by interconnecting with mounting structures 64 on the side supports 17. The front brackets 38a are bolted or screwed onto the side supports 17. Alternately, the shelves 12 may be connected to the frame 20 in another manner.

In the embodiment illustrated in FIGS. 1-3, the shelves 12 are supported by the frame 20, and hang downwardly and outwardly from the central support 19. The shelves 12 in the front section 21a are angled forward to better display the food items 14 thereon, while the shelves 12 of the rear section 21b are angled rearward. This arrangement allows the display case 10 to display food items 14 when viewed from either the front or the rear.

An assembled shelf 12 of the present invention is illustrated in FIGS. 4-5, and the assembly of the three layers 50,52,54 of the shelf 12 is illustrated in FIGS. 6-8. As shown in FIGS. 6-8, the preferred plastic substrate 66, embedded with wires 58 and bus bars 60 (i.e., the third layer 54), is placed between the first glass layer 50 and the second glass layer 52, and the layers 50,52,54 are pressed together and autoclaved (heated) to bond the layers 50,52,54 to each other and form the pane 30. The pane 30 is also preferably sealed around the periphery to ensure air tightness. Then, the divider 34 and the extrusion 36 are mounted on the pane 30, along with the support assembly 32. The assembled shelf 12 is ready for mounting on the frame 20, as described above, once the support assembly 32 is connected to the shelf 12.

The power source 11 is preferably a connection to a 120 V electrical outlet, such as an electrical cord 11a, as shown in FIGS. 1-3. The power source 11 preferably runs through the top of the display case 10 and is then routed to the appropriate components of the case 10. As shown in FIG. 6, the bus bars 60 are connected to the power source 11 via connecting wires 11b to supply electricity to the heating element 56. The controller 13 is preferably mounted in the base 18 and is connected to the power source 11. Preferably, the controller 13 regulates the power source 11.

Food items 14, such as cookies and other baked goods, are preferably placed on the shelves 12 of the display case 10. The divider 34 and the extrusion 36 support the food items and prevent the food items from sliding off the angled shelves 12. The controller 13 is used to turn the power source 11 on, supplying power to the shelves 12. The controller 13 can also be adjusted to control the amount of power supplied to the shelves 12, thereby controlling the temperature of the shelves 12. In the preferred embodiment, the shelves 12 can be operated at temperatures up to approximately 200° F. However, in other embodiments, the display case 10 can be modified to permit for a larger or smaller range of operating temperatures.

The display case 10 provides many benefits. The heated shelves 12 provide surfaces to support and display many food items 14, while also keeping the food items 14 warm. Warm food items 14 are often more desirable to consumers, and thus, the heated display case 10 can increase sales of food items when set up in a retail or other commercial establishment. The adjustable temperature feature allows an operator to customize the display case 10 for different types of food items 14. Additionally, the generally transparent shelves permit food items 14 placed on a lower shelf 12 to be viewable through an overhanging upper shelf 12. Thus, a larger number of food items 14 can be placed on each shelf 12, while remaining visible to consumers. The display case 10 provides other benefits as well.

While the specific embodiments have been illustrated and described, numerous modifications come to mind without significantly departing from the spirit of the invention, and the scope of protection is only limited by the scope of the accompanying Claims.

1. An apparatus for warming a food item comprising:
a shelf adapted to support the food item, the shelf comprising a first layer, a second layer, and a third layer positioned between the first layer and the second layer, wherein the third layer comprises a substrate having a heating element embedded therein, the heating element adapted to be connected to a power source; and
a support structure supporting the shelf.

2. The apparatus of claim 1, wherein the shelf is adapted to be heated to a temperature of up to approximately 200° F.

3. The apparatus of claim 1, wherein the heating element comprises a resistive wire.

4. The apparatus of claim 3, wherein the heating element further comprises a bus bar connected to the resistive wire, the bus bar adapted to be connected to the power source.

5. The apparatus of claim 1, wherein the first layer, the second layer, and the third layer are generally transparent, providing a generally transparent shelf.

6. The apparatus of claim 1, wherein the substrate is generally transparent.

7. The apparatus of claim 1, wherein the third layer is in substantially continuous contact with the first layer and the second layer.

8. The apparatus of claim 1, wherein the heating element comprises a mesh of resistive wires.

9. The apparatus of claim 8, wherein the third layer further comprises a generally transparent substrate, and the mesh of resistive wires is embedded within the substrate.

10. The apparatus of claim 1, wherein the first layer and the second layer are made of glass and the substrate of the third layer is made of plastic.

11. The apparatus of claim 1, wherein the shelf further comprises a divider extending across the shelf and adapted to abut the food item when the food item is placed on the shelf.

12. The apparatus of claim 1, wherein the support structure comprises a base and a frame extending upward from the base and supporting the shelf in spaced relation to the base, the frame comprising a first vertical support connected to a first edge of the shelf and a second vertical support connected to an opposed second edge of the shelf.

13. The apparatus of claim 12, wherein the frame further comprises a central vertical support positioned between the first vertical support and the second vertical support, the central support having a first side and a second side, and the apparatus further comprises a plurality of shelves identical to the first shelf, each of the plurality of shelves supported by the frame such that an equal number of the plurality of shelves hang downwardly and outwardly from the first side and the second side of the central support.

14. A heated shelf for a display case, the shelf comprising:
a first generally transparent layer;
a second generally transparent layer; and
a third generally transparent layer positioned between the first layer and the second layer and in substantially continuous contact with the first layer and the second layer, wherein the third layer comprises a generally clear substrate and a heating element embedded within the substrate.

15. The shelf of claim 14, wherein the heating element comprises a resistive wire.

16. The shelf of claim 14, wherein the heating element comprises a plurality of resistive wires.

17. The shelf of claim 14, wherein the heating element comprises a mesh of resistive wires.

18. The shelf of claim 14, wherein the first layer and the second layer are made of glass and the substrate of the third layer is made of plastic.

19. The shelf of claim 14, wherein the third layer has a planar top surface and a planar bottom surface, and wherein the planar top surface is substantially continuously bonded to the first layer, and the planar bottom surface is substantially continuously bonded to the second layer.

20. A heated display case adapted to support a plurality of food items comprising:
a first generally transparent shelf adapted to support a plurality of food items, comprising a first generally transparent glass layer, a second generally transparent glass layer, and a third generally transparent layer positioned between the first layer and the second layer and in substantially continuous contact with the first layer and the second layer, wherein the third layer comprises a generally clear plastic substrate and a plurality of resistive wires embedded within the substrate;
a second generally transparent shelf adapted to support a plurality of food items, comprising a first generally transparent glass layer, a second generally transparent glass layer, and a third generally transparent layer positioned between the first layer and the second layer and in substantially continuous contact with the first layer and the second layer, wherein the third layer comprises a generally clear plastic substrate and a plurality of resistive wires embedded within the substrate, the second shelf positioned above the first shelf, wherein the first shelf is generally visible through the second shelf;
a base;
a frame extending upward from the base, the frame comprising a first vertical support and a second vertical support oriented substantially parallel to the first vertical support, the frame supporting the first and second shelves in spaced relation to the base such that each of the first and second shelves is supported by the first vertical support and the second vertical support; and
a power source coupled to the resistive wires of the first shelf and the resistive wires of the second shelf.
